(19) United States
(12) Patent Application Publication
(10) Pub. No.: US 2002/0184865 A1
(43) Pub. Date: Dec. 12, 2002

(54) Walk behind gang mower

(76) Inventor: Douglas Jay Short, Ft. Wayne, IN (US)

Correspondence Address: Michael B. McNeil, Liell & McNeil Attorneys PC, P.O. Box 2417, Bloomington, IN, 47402, US

(21) Appl. No.: 10/178,113

(22) Filed: Jun. 24, 2002

Related U.S. Application Data
(63) Continuation-in-part of application No. 09/484,920, filed on Jan. 18, 2000.
Application No. 09/484,920 is a continuation-in-part of application No. 09/211,375, filed on Dec. 14, 1998, now Pat. No. 6,058,687.
Application No. 09/211,375 is a continuation of application No. 08/860,682, filed on Jun. 10, 1997, now Pat. No. 5,865,017.
Application No. 08/860,682 is a continuation of application No. 08/370,664, filed on Jan. 10, 1995, now Pat. No. 5,497,603.

(51) Int. Cl. A01D 75/30

(52) U.S. Cl. 56/7

(57) ABSTRACT

A walk behind gang mower includes a frame with a plurality of reel-type mowers attached to the frame. The user, along with motors and propulsion wheels, propel the walk behind gang mower forward and rotate the cutting reel. The rear rollers of the reel-type mower unit support the majority of the frame's weight such that the motor indirectly operates the cutting reel by rotation of the propulsion wheel. Movement of the mower rotates the forward drive wheels of the reel type mower(s), which in turn, rotate the cutting reel(s). The user uses a steering controller to adjust the power delivered to the propulsion wheels so that the walk behind gang mower can be easily turned.

### RELATION TO PRIOR APPLICATIONS

This application is a continuation-in-part of U.S. patent application Ser. No. 09/484,920, filed on Jan. 18, 2000, and entitled Gang Mower, now U.S. Pat. No. ______, which was a continuation-in-part of U.S. patent application Ser. No. 09/211,375, filed on Dec. 14, 1998, and entitled Gang Mower, now U.S. Pat. No. 6,058,687, which was a continuation of U.S. patent application Ser. No. 08/860,682, filed Jun. 10, 1997, and entitled Gang Mower, now U.S. Pat. No. 5,865,017, which was a continuation of U.S. patent application Ser. No. 08/370,664, filed Jan. 10, 1995, and entitled Gang Mower, now U.S. Pat. No. 5,497,603.

### TECHNICAL FIELD

The present invention relates generally to reel-type mowers, and in particular to walk-behind gang mowers.

### BACKGROUND OF THE INVENTION

Gang mowers have long been known in the art, and are most often identified with golf courses and other wide open areas requiring an attractive contoured cut. Gang mowers are often recognized for their ability to mow a given area in a significantly shorter amount of time than that possible with conventional powered deck mowers. This is due in part to the relatively large swath (8 feet or more) possible with gang mowers, whereas deck mowers typically cut a swath of four feet or less with each pass. However, most previous gang mowers include a frame that attaches to the rear portion of a tractor and is moved behind the same. While these rear mounted gang mowers have performed effectively, there are some drawbacks associated with their use. For instance, because the mower units follow the tractor, one or more paths from the tractor's tires are flattened in the grass before the grass is cut by the mower units. Therefore, unevenly mowed patches of grass can result. Additionally, because the mower units are behind the user, he or she must turn toward the rear of the mower, and away from the direction the tractor is being driven, to monitor the condition of the mower units and mowing progress. This can add unnecessary time and inconvenience to the mowing process. Furthermore, there are times when a condensed cutting area does not lend itself to the size associated with a tractor pulling a gang mower.

Previous front mounted mowers have been designed to correct some of the drawbacks set out above but did not offer a solution for the many occasions of a smaller lawn area requiring more precise maneuverability. In those situations, a walk-behind mower was the preferred equipment, but previous walk-behind mowers have usually comprised of only one reel-type mower unit. This singular arrangement offered the precision needed for smaller areas but sacrificed too much in the cutting swath. When a plurality of mower units were combined, extensive hydraulic motors were often required to operate the mower effectively. This fact required a large increase in weight and size, while increasing the energy consumption of the mower.

The present invention is directed to overcoming one or more of the problems set forth above.

### SUMMARY OF THE INVENTION

In one aspect of the present invention, a plurality of reel-type mowers are attached to a frame. At least one propulsion wheel, which is operably connected to at least one motor, is also attached to the frame.

Another aspect of the present invention covers a method of mowing grass. The method includes the step of moving a plurality of reel-type mowers using at least one motor coupled with at least one propulsion wheel. The cutting reels of the reel-type mowers are rotated by at least one drive wheel. The mower is steered at least in part by walking behind, and grasping onto, a frame attached to the reel-type mowers.

### BRIEF DESCRIPTION OF THE DRAWINGS

FIG. 1 is a top view of a gang mower for garden tractors.

FIG. 2 is a side elevational view of the gang mower of FIG. 1.

FIG. 3 is a front elevational view of the gang mower of FIG. 1 in its stowed configuration.

FIG. 4 is an enlarged side elevational view of a portion of a gang mower frame.

FIG. 5 is a side diagrammatic illustration of a reel-type mower unit contrasting the force distribution of the frame of the present invention versus that of the prior art.

FIG. 6 is a top view of a rear mounted gang mower for garden tractors.

FIG. 7 is a top view of a walk behind gang mower according to the present invention.

FIG. 8 is a front view of the walk behind gang mower frame shown in FIG. 7.

FIG. 9 is a side view of the walk behind gang mower frame shown in FIG. 7.

### DETAILED DESCRIPTION OF THE PREFERRED EMBODIMENTS

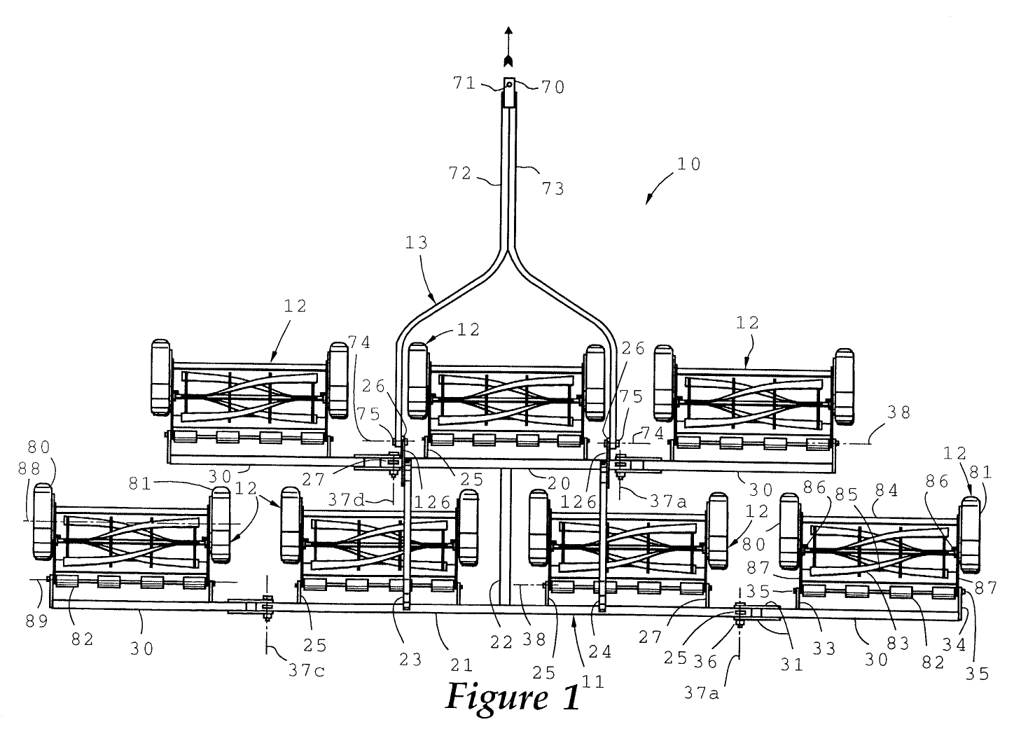

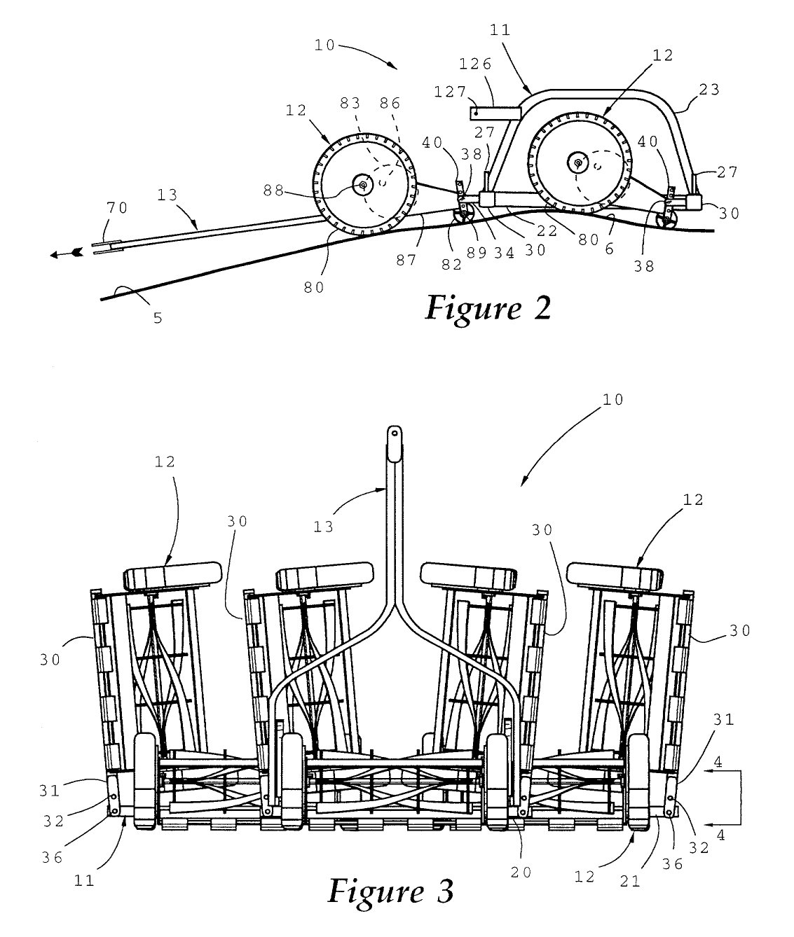

Referring now to FIG. 1, a gang mower for garden tractors 10 includes a frame 11, a hitch 13 and seven individual reel-type mower units 12. Frame 11 preferably includes a central portion made up of a forward sub-frame 20 and a rearward sub-frame 21 arranged behind and substantially parallel to the forward sub-frame. Sub-frames 20 and 21 are preferably interconnected by a horizontal stiffener 22 and a pair of arched stiffeners 23 and 24. Forward sub-frame 20, rearward sub-frame 21 and horizontal stiffener 22 are preferably made from square metal tubing welded to one another in a conventional manner. Arched stiffeners 23 and 24 are preferably formed from square steel bar stock and welded at each end to the forward and rearward sub-frames. The preferred shape of the arched stiffeners 23 and 24 is best illustrated in FIG. 2.

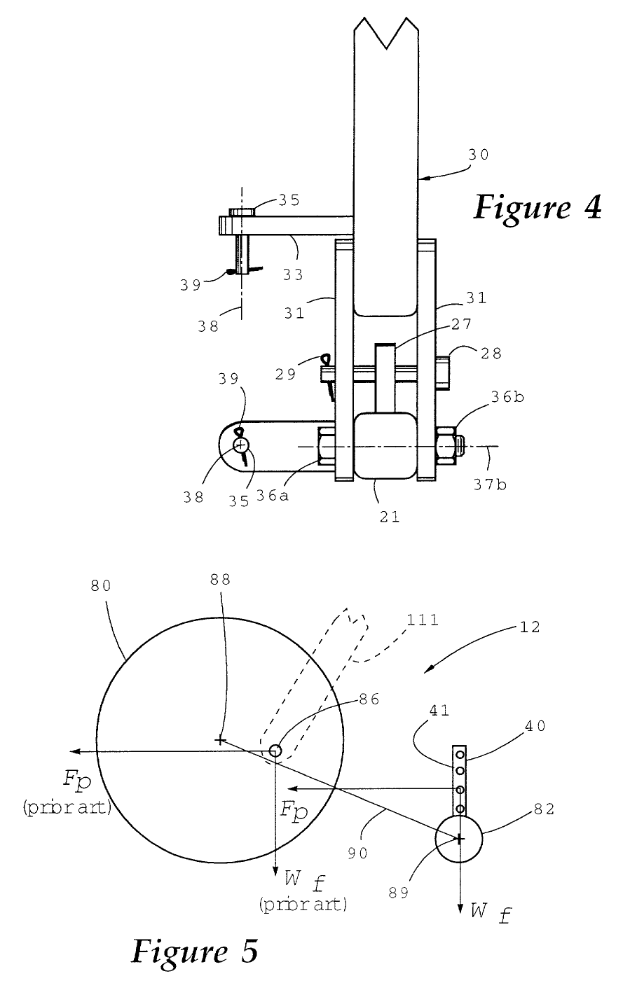

A pair of mower attachment brackets 25 are preferably welded to extend forward of forward sub-frame 20, and serve as a means by which the central mower in the front row is attached to the frame. Likewise, four substantially identical brackets 25 are preferably welded to extend forward of the rearward sub-frame 21, and serve as a means by which the central two mower units 12 in the second row are attached to the frame. Brackets 25 are preferably cut from steel bar stock, on the order of at least one quarter inch thick, and welded into place. Each of brackets 25 includes a bore that facilitates attachment of the individual mower units 12 through a pin arrangement (best illustrated in FIG. 4) that permits the individual mower units to pivot with respect to the frame about horizontal pivot axes 38. This aspect of the invention allows the individual mower units to independently pivot and follow contours 6 encountered as the gang mower is moved forward over the ground 5, as shown in FIG. 2.

Hitch 13 is preferably attached to frame 11 via a pair of brackets 26 that are substantially similar to brackets 25 discussed earlier. Brackets 26, which are partially obscured in FIG. 1 by upper brackets 126, are welded to, and extend forward from, forward sub-frame 20. When the gang mower is reduced to three central mower units and the mower is to be moved by a draft animal, upper brackets 126 (see also FIG. 2) are used as the mounting location for hitch 13 via bore 127. Upper brackets 126 are welded to arched stiffeners 23 and 24. Hitch 13 preferably includes a pair of symmetrically bent square steel bars 72 and 73. Bars 72 and 73 are bent generally into the shape shown in FIG. 1 and are preferably welded at a number of locations along their contact surfaces. A pair of flanges 70 are attached to one end of bar 72 and 73. Flanges 70 are preferably made from steel bar stock on the order of about one quarter inch in thickness and are machined to include a bore 71, which facilitates hitching the gang mower to an ordinary garden tractor in a conventional manner. The other end of bars 72 and 73 include a bore (not shown) which facilitates the attachment of hitch 13 to brackets 26 via a pair of nut/bolts 75. Thus, hitch 13 preferably has the ability to pivot with respect to frame 11 about axis 74 to better facilitate the gang mower following contours when going over the top of hills or the bottom of valleys between hills. Furthermore, this feature allows the hitch to be pivoted to an upright stowed position (FIG. 3) to better facilitate storing the gang mower in a relatively small space.

Attached to the rigid central frame 11 are four outer sub-frames 30. In particular, FIG. 1 shows a forward left sub-frame, a forward right sub-frame, a rearward left sub-frame and a rearward left sub-frame. Although the outer sub-frames 30 are located in different positions and inverted with respect to one another, their individual structures are substantially identical. In particular, each outer sub-frame 30 preferably includes a length of square tubular stock welded adjacent one end to a pair of extension members 31, which are preferably cut from a length of steel bar stock on the order of about one quarter inch in thickness. Extensions 31 each preferably include a bore that permits attachment to the central frame 11 via a nut/bolt set 36, as best shown in FIG. 4. This permits the outer sub-frames to pivot about individual horizontal axes 37a-d. This allows the outer mower units to float with the contour of the lawn independently of one another. Also, outer sub-frames 30 have the ability to pivot to an upright stowed position (FIGS. 3 and 4) in order to better facilitate storage of the gang mower in a relatively small space. Outer sub-frames 30 also preferably include a pair of brackets 33 and 34 which are substantially similar to brackets 25 discussed earlier, except that bracket 34 is slightly longer and welded to one end of the particular outer sub-frame 30. Brackets 33 and 34 preferably include a bore that facilitates an attachment of a mower unit 12 via a pin arrangement that permits pivoting about a horizontal axis 38. Thus, the outer sub-frames can pivot about first horizontal axes 37a-d and each of the mower units can pivot about a separate and perpendicular horizontal axis 38. This permits the outer mower units to have two degrees of rotational freedom so that gang mower 10 can easily follow virtually any ground contour.

The individual reel-type mower units 12 are commercially available from a variety of known sources, and often can be utilized without modification. Each mower unit includes a pair of forward drive wheels 80 and 81 that define a localized forward axis 88. Each mower also preferably includes a rear roller 82 with the ability to rotate about a localized rearward axis 89. Real roller 82 and forward drive wheels 80, 81 are preferably interconnected via a pair of supports 87. Rotating blades 83 are attached between supports 87 and are driven to rotate adjacent cutting reel 85 when forward drive wheels 80 and 81 are rotated in the forward direction. A stabilizer bar 84 extends between brackets 87, and apparently serves to give the individual mower unit 12 greater rigidity. The mower units sometimes include a pair of handle mounting studs 86 which will be discussed infra in relation to FIG. 5. Thus, mower units 12 can be “off the shelf” components except that the individual handles for the reel-type mowers are excluded. Cutting height can be adjusted by connecting the rear roller 82 to different locations along height adjustment bracket 40 (see FIGS. 2 and 5). Height adjustment brackets are positioned and attached within a channel on supports 87.

The gang mower permits a portion of the individual mower units 12 to pivot about a pair of mutually perpendicular horizontal axes with respect to one another. Furthermore, the pivoting ability of the hitch better facilitates cutting over the top and at the bottom of relatively steep hills. However, it should be noted that preferably the mower units have little or no ability to rotate with respect to one another about any vertical axis. This permits the user to back up the gang mower 10 without risking the jack-knifing problems encountered with prior art mower units that have the ability to rotate with respect to one another about a vertical axis. This feature also permits the mower to effectively complete zero radius turns while maintaining the proper overlapping cutting arrangement afforded by the two staggered rows of gang mowers shown in FIG. 1.

Although the gang mower 10 shown in FIG. 1 includes seven individual mower units 12, it can also utilize either five or three mowers if a thinner mower swath is desirable. In its basic form, preferably only the central frame 11 is included with three individual mower units, giving the overall gang mower a cutting swath on the order of about four feet. The next extension up to approximately a six foot cutting swath is accomplished by adding a pair of outer sub-frames 30 to forward sub-frame 20 as discussed earlier. Such a configuration would have three mowers in the front row and two mowers in the back row and have a cutting swath on the order of about six feet or more. The next enhancement comes by adding another pair of mower units 12 to the rearward sub-frame 21 via another pair of outer sub-frames 30. In addition to these enhancements, gang mower 10 could include seven mower units 12, such that four mowers are in the front row and two mowers are in the back row (See FIG. 9). Thus, it should be clear that gang mower 10 has the versatility to accommodate several different cutting swaths to suit virtually any individual user. Furthermore, maintenance on gang mower 10 is relatively low since the individual mower units can be replaced at a relatively low cost and the underlying frame is virtually maintenance free. Prior art mower units are typically specially modified for use in the gang mower and often require costly maintenance and repairs when problems occur.

FIG. 3 shows the gang mower 10 of FIG. 1 in its stowed configuration for storage. Each of the outer sub-frames 30 preferably has the capability of pivoting about its individual axis 37a-d (FIG. 1) to an upright stowed position. The outer sub-frames 30 can be locked in their stowed configuration via the pin arrangement illustrated in FIG. 4. In particular, at the connection with each outer sub-frame 30 an upright bracket 27 is welded to the underlying sub-frame 20 or 21 (see FIGS. 1, 2 and 4). Upright brackets 27 each preferably include a bore which aligns with bores made through extensions 31. When in the stowed configuration, these bores align and permit the insertion of a pin 28 which is kept in place via a retaining pin 29, or another equivalent arrangement known in the art. Thus, each of the outer units is locked in an upright stowed position and the hitch is pivoted to an upright stowed position when it is desired to store the gang mower. If proper clearances are maintained, the gang mower can still be moved forward or pushed in reverse when in its stowed configuration as shown in FIG. 3. In such a case, the weight of the gang mower, which is typically on the order of about 200 pounds, is supported by the three central mower units. Thus, the user can quickly pivot and lock the outer mower units to their stowed configuration and simply back the gang mower into a storage place within a garage or barn. Gang mower 10 takes up the space about equal to that of a motorcycle when in its stowed configuration, or less than half the space of its deployed configuration as shown in FIG. 1.

FIG. 4 is an enlarged view illustrating the interconnection between rearward right sub-frame 30 and rearward sub-frame 21. Nevertheless, the attachment of each outer sub-frame to the central frame is identical since all the outer sub-frames are structurally identical. As discussed earlier, the framing is preferably attached to the individual mower units via a pin arrangement 35 that permits the mower units to pivot about an axis 38. Outer sub-frame 30 is attached to rearward sub-frame 21 via aligning bores (not shown) which receive a bolt 36a. The bolt is preferably secured in place with a conventional nut 36b. When the outer sub-frame 30 is pivoted to its upright stowed configuration, the bores in extensions 31 and upright bracket 27 align and permit the insertion of a pin 28. Pin 28 is preferably held in place via a removable retaining pin 29 that is inserted through a hole in one end of pin 28. When the outer sub-frames 30 are lowered into their deployed configuration, pin 28 is reinserted through bracket 27 and left in place until needed. The pin and retaining pin arrangement shown for attaching the frames to the individual mower units and for locking the outer sub-frames in an upright position could have a variety of other mechanical connections substituted therefore which are known in the art. For instance, a nut and bolt arrangement could be substituted for each of the pin/retaining pin connections illustrated.

Referring now to FIG. 5, the force distribution aspect of the present invention is contrasted with that of the closest known prior art (U.S. Pat. No. 4,287,706 to Tobin, Jr.). In particular, FIG. 5 shows a diagrammatic view of a mower unit 12 having a forward wheel 80 that is rotatable about a forward axis 88. The rear roller 82, which is rotatable about a rearward axis 89 is preferably attached to the forward mower via a height adjusting bracket 40. The present invention is preferably attached directly above rearward axis 89 so that most of the weight of the frame (Wf) is supported by the rear rollers. Although the present invention would perform well with the mowers attached either for or aft of rearward axis 89, attaching directly above rearward roller 82 is the most easily facilitated because height adjusting bracket 40 typically includes several bores for adjusting the height of rollers 82. It is also important to note that the frame is preferably attached lower than forward axis 88 but higher than rearward axis 89. The result being that the force (Fp) supplied by moving or pushing the gang mower always intersects a line 90 connecting axis 88 and axis 89. Preferably, the combined force from Fp and Wf intersects line 90 so that the drive wheels are leveraged downward while maintaining the roller in contact with the ground. Thus, the present invention contemplates a wide variety of attachment locations, including ones above axis 88, provided that an adequate force balance is maintained to drive the front wheels and maintain the rear roller in contact with the ground. The result being that each individual mower unit is leveraged downward via a torque about the rear roller axis when moved forward to increase the friction contact between drive wheels 80, 81 and the ground. This contrasts with the Tobin connection via a bracket 111 that attaches to handle studs 86. Handle studs 86 are typically located relatively close to forward axis 88. Thus in the Tobin mower, the majority of the frame's weight is supported by the forward wheels rather than the rear roller. The consequence being that the rear roller tends to bounce along the ground when the Tobin mower is moved forward. Tobin attempted to eliminate this problem by including a spring which constantly supplies a restoring moment to maintain the rollers in contact with the ground. The present invention solves the roller bouncing problem inherent in the Tobin gang mower.

It should be appreciated that while the present invention has been shown with mower units 12 being attached to the frame at a location closer to the rear rollers 82 than the forward drive wheels 80, 81, the present invention contemplates solving the roller bouncing problem by placing sufficient force on rear rollers 82 to keep them in contact with the ground. In other words, because the cutting real is located at a fixed distance from the ground when rear roller 82 and forward drive wheels 80, 81 are on the ground, it is important that a sufficient amount of the weight of frame 11 is supported by rear roller 82 to keep it on the ground. While the present invention has been illustrated supporting a majority of the weight of the frame by rear rollers 82 by attaching the frame closer to rear rollers 82 than forward drive wheels 80, 81, the location of the attachment of the frame to mower units 12 is only important in relation to the downward force acting on rear roller 82. In other words, so long as a sufficient downward force is acting on rear roller 82 to keep the same on the ground during cutting, it should be appreciated that frame 11 could be attached to mower units 12 at any point between rear roller 82 and forward drive wheels 80, 81.

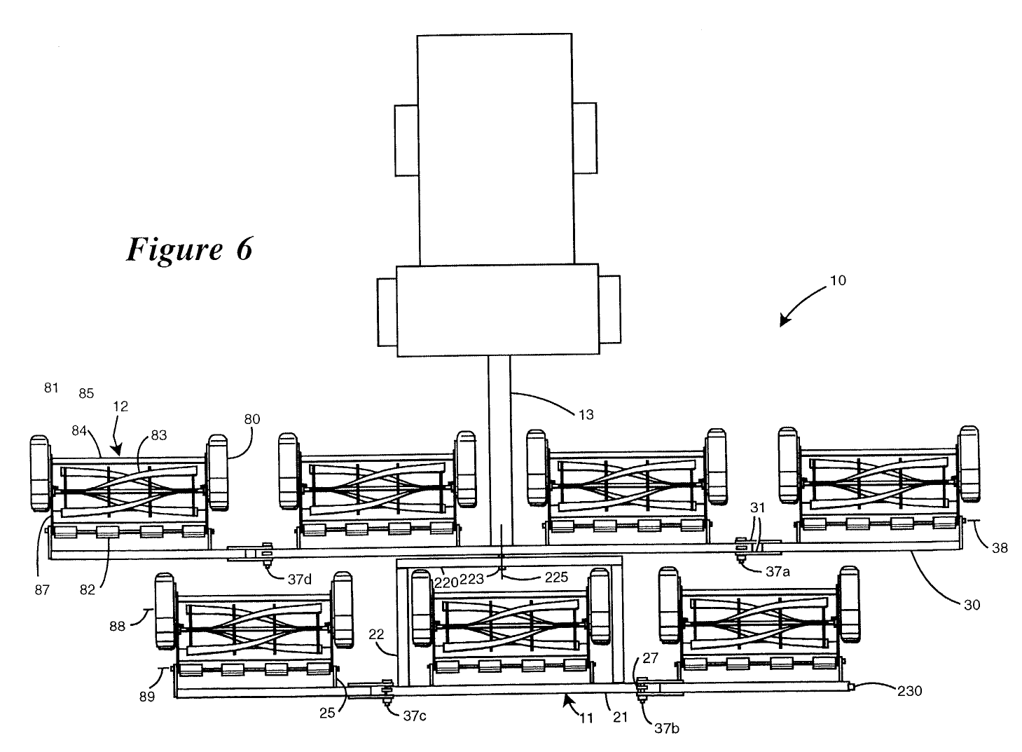

Referring now to FIG. 6, rear mounted gang mower 10 of FIGS. 1-5 could be modified to provide a user with even greater versatility and convenience. For instance, one manner in which gang mower 10 can be modified has been shown in FIG. 9. As illustrated, gang mower 10 still preferably includes three, five or seven reel-type mower units 12. However, in this modification, four mower units 12 have been included on forward sub-frame 20 and three have been included on rearward sub-frame 21. In this aspect, forward sub-frame 20 and rearward sub-frame 21 are preferably connected by a pair of horizontal stiffeners 22. A secondary sub-frame 220 is included on gang mower 10 and is preferably attached to forward sub-frame 20 and horizontal stiffeners 22. A bolt 223 preferably attaches the stabilizer bar 84 of central, rear mower unit 12 to secondary sub-frame 220. This feature allows the central, rear mower unit to pivot about a roll axis 225 that passes through bolt 223. In other words, central, rear mower unit 12 has the ability to pivot about roll axis 225 in a manner that allows it to better follow the contours of the ground. In addition to this increased ability to follow the contours of the ground, gang mower 10 can also be modified to increase convenience for the user. As best shown in FIGS. 3 and 4, outer sub-frames 30 can preferably pivot about their individual axes 37a-d to a stowed configuration. In the modification to gang mower 10 shown in FIG. 9, a handle 230 has been attached to each outer sub-frame 30. Handle 230 can be used to better facilitate adjusting gang mower 10 between the stowed or deployed configurations and can be attached to outer sub-frames 30 in any conventional manner and can be formed from any suitable material.

It should be understood that the above description is intended to serve only in aiding those skilled in this art to understand the gang mower, and is therefore intended for illustrative purposes only. Although a number of enhancements to the gang mower have been discussed above, those skilled in the art may also recognize additional enhancements. For instance, a spiked roller could be substituted for the smooth rollers 82 illustrated for purposes of allowing the user to aerate their lawns as they mow. Another variation might be accomplished by utilizing reel-type mowers that have no rear roller. In such a case, the frame might be supported by its own rollers or wheels attached at strategic locations with the ability to adjust the height of the frame off the ground in order to adjust the cutting height of the individual mower units. Thus, while it may be preferable to use off the shelf reel-type mowers, modifications can be made to the illustrated gang mowers.

Still other enhancements to the illustrated gang mowers might include utilizing the present frame with a plurality of golf ball retrievers substituted in place of the reel-type mower units. Such an alternative might prove attractive in retrieving balls at driving ranges. The could also be utilized as a support frame for a number of other lawn implements including aerators, fertilizer units, or any other suitable lawn implement that could be substituted for, or added to, the reel-type mower units illustrated. There is also the possibility of attaching implements requiring electrical power to the frame of the and supplying power via a hook up to the alternator or battery of the garden tractor. This possibility may be especially attractive in attaching a number of weed eater units to the frame in order to cut any stemmy weeds or fesque grasses that are difficult to cut in a single pass with a reel-type mower. Finally, there is also the possibility of mounting a fertilizer tank on the frame and running a number of nozzles from the tank along the rearward base of the frame so that the user could distribute liquid fertilizers over their lawn while cutting.

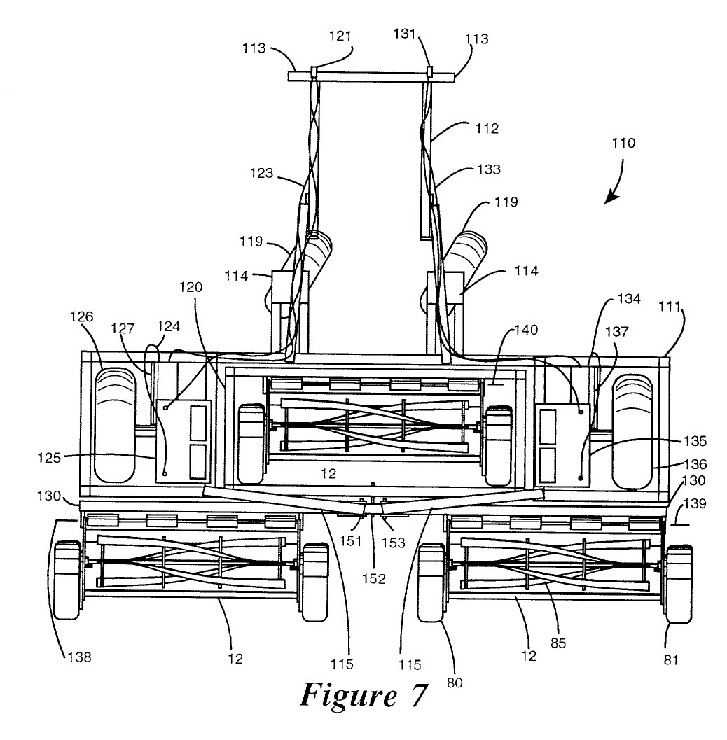

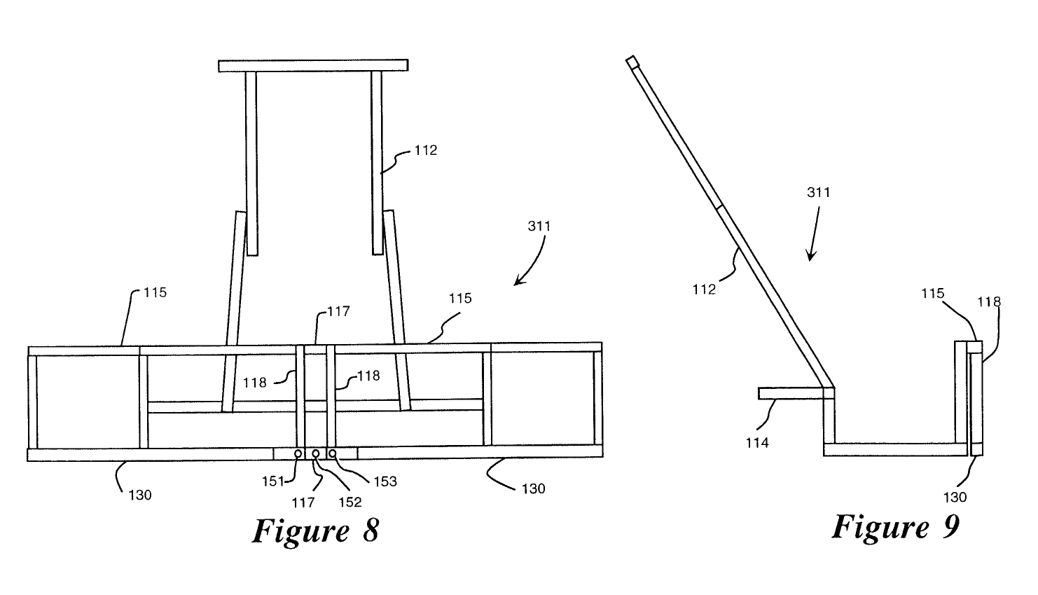

Referring now to FIGS. 7-9, a walk behind gang mower 110 includes a frame 111 and three reel type mower units 12. Frame 11 is preferably constructed from steel tubular stock segments that are welded or otherwise attached to one another in a conventional manner. Frame 111 includes handle bars 112, behind which the operator walks when gripping the mower frame at gripper locations 113. Adjacent gripper locations 113 are a right controller 121 and a left controller 131, respectively. Right controller 121 is connected to a battery 125 and a motor 127 via right control line 123 and motor power line 124 in a conventional manner. Preferably, right controller 21 is a thumb operated variable controller. In other words, the power supplied to motor 127 is preferably proportional to the deflection distance of controller 121. Alternatively, controller 121 could be a simple on/off switch, which is preferably biased to an off position. The power produced by motor 127 is supplied to right propulsion wheel 126 in a conventional manner. Thus, when right controller 121 is depressed, right propulsion wheel 126 is driven to rotate and propel the right hand portion of mower 110 forward. Left controller 131 works much in a similar manner. Left controller 131 is connected to a separate battery 135 and separate mower 137 via left controller line 133 and motor power line 134. Thus, when controllers 121 and 131 are depressed, the entire mower 110 is driven forward. Turning is accomplished in a manner similar to a tracked vehicle wherein a right hand turn is accomplished by slowing or stopping power to right propulsion wheel 126, whereas a left hand turn is accomplished by slowing or stopping power to left propulsion wheel 136.

In order to limit the amount that frame 111 can pitch about the axis of propulsion wheels 126 and 136, a pair of frame support wheels 119 are pivitably attached to frame extensions 114 respectively. Two frame support wheels 219 are preferably provided in a spaced apart relationship as shown so as not to interfere with the walking motion of an operator. Nevertheless, those skilled in the art will appreciate that a single or possibly even no support wheel could be included without departing from the present invention.

Each of the mower units 12 is preferably attached to frame 111 in a way that allows it to rotate about a pitch axis and a roll axis independent of the other mower units, and preferably independent of frame 111. In this way, the right hand mower unit is preferably attached to a wing 130 that is attached to frame 111 at a pivot point 151 that provides a roll axis for the right hand mower unit. In addition, the right hand mower unit is attached to the frame in a manner similar to that of the previously described gang mower such that it can pitch up and down about a pitch axis 138. The left hand mower unit is attached in much the same way such that it is attached to wing 130 to include a pitch axis 139 and a roll axis 153. The central mower unit is contained within a separate internal rectangular shaped sub-frame 120. The central mower unit is attached to subframe 120 in a manner as previously described such that it can pitch about a pitch axis 140. In addition, the internal sub-frame 120 can roll about a roll axis 152. In other words, internal sub-frame 120 is connected to frame 111 via a suitable connection, such as a bolt, which permits subframe 120 to rotate to about roll axis 152 with respect to frame 111. These various pivotal attachments allow the individual mower units to adjust independently to the ground contour, yet all three mowers remain fixed with respect to one another about a vertical yaw axis. The various pivotal and fixed attachments are accomplished by including a pair of slanted members 115 that connect to a vertical rectangular shaped portion made up of a pair of horizontal members 117 attached to vertical members 118.

The present invention also contemplates a method of mowing grass involving a first step of moving a plurality of reel-type mower units 12 forward. This movement is accomplished by coupling at least one motor 127, 137 with at least one propulsion wheel 126, 136. The second step requires the rotation of a cutting reel 85 on the individual reel-type mower units 12. This rotation is accomplished, at least in part, by rotating forward drive wheels 80 and 81 of the individual reel-type mower units 12. The final step of mowing grass involves the steering of the plurality of reel-type mower units 12. This step is accomplished by the user grasping onto gripper portions 113 and walking behind the walk behind gang mower 110.

Steering of walk behind mower 110 is preferably accomplished by reducing or ceasing power to one of the left or right propulsion wheels while undergoing a turn. Thus, steering is accomplished much in a manner similar to a track type vehicle, such as a bulldozer. Those skilled in the art will appreciate that propulsion wheels 126 and 136 are positioned behind the front mower units so that no grass is flattened before encountering mower units 12. In addition, those skilled in the art will appreciate that the drive wheels 80 and 81 of the individual mower units are driven to rotate when the mower 110 moves forward due to a friction interaction between the ground and drive wheels 80 and 81. This friction interaction is enhanced by the fact that frame 111 produces a torque about the rear rollers of the mower units when mower 110 moves forward. This torque tends to leverage the drive wheels 80 and 81 into contact with the ground. In addition, the rear rollers are maintained in contact with the ground since much of the weight of frame 111 is still supported by the rear rollers of the mowers, even in the presence of propulsion wheels 126, 136 and support wheels 119. Although the mower 110 has been illustrated as including separate motors and batteries, those skilled in the art will appreciate that with suitable power distributing hardware, the present invention could be accomplished with a single power source (battery) and a single motor. In addition, the present invention might also utilize a single centrally located propulsion wheel as an alternative to the dual propulsion wheels illustrated.

The above description is for illustrative purposes only, and is not intended to limit the scope of the invention in any way. Those skilled in the art will appreciate that a wide variety of modifications could be made to the illustrated mowers without departing from the intended scope of the invention, which is defined by the claims set forth below.

1. A walk behind gang mower comprising:
a frame;
a plurality of reel-type mowers attached to said frame, and each having a pair of drive wheels operably coupled to a rotatable cutting reel;
at least one propulsion wheel attached to said frame; and
at least one motor mounted on said frame and being operably coupled to said propulsion wheel.

2. The walk behind gang mower of claim 1 wherein each of said plurality of reel-type mowers includes a rear roller rotatable about a roller axis; and
said frame applying a torque about an axis parallel to roller axis to each of said reel-type mowers when moving in a forward direction.

3. The walk behind gang mower of claim 1 wherein at least one propulsion wheel includes a first propulsion wheel and a second propulsion wheel; and
a steering controller attached to said frame and operably coupled to distribute power to said first propulsion wheel and said second propulsion wheel.

4. The walk behind gang mower of claim 1 wherein said at least one motor includes at least an electric motor; and
at least one power source supported on said frame and electronically connected to said at least one electric motor.

5. The walk behind gang mower of claim 1 wherein said plurality of reel-type mowers are pivotable with respect to each other about at least one roll axis and at least one pitch axis.

6. The walk behind gang mower of claim 2 wherein said plurality of reel-type mowers are pivotable with respect to each other about at least one roll axis and at least one pitch axis.

7. The walk behind gang mower of claim 6 wherein said at least one motor includes at least an electric motor; and
at least one power source supported on said frame and electronically connected to said at least one electric motor.

8. The walk behind gang mower of claim 7 wherein at least one propulsion wheel includes a first propulsion wheel and a second propulsion wheel; and
a steering controller attached to said frame and operably coupled to distribute power between said first propulsion wheel and said second propulsion wheel.

9. A method of mowing grass, comprising the steps of:
moving a plurality of reel-type mowers forward at least in part by coupling at least one motor to at least one propulsion wheel;
rotating a cutting reel at least in part by rotating drive wheel portions of said reel-type mowers; and
steering said plurality of mowers at least in part by walking behind, and grasping onto, a frame attached said reel-type mowers.

10. The method of mowing grass of claim 9 wherein said moving step includes a step of providing electric power to an electric motor.

11. The method of mowing grass of claim 10 wherein said steering step includes a step adjusting a torque to each of said at least two propulsion wheels.

12. The method of mowing grass of claim 10 adjusting to ground contours at least in part by pivoting said reel-type mowers relative to one another.

13. The method of mowing grass of claim 10 wherein said rotating step includes applying a torque to said reel-type mowers about axes parallel to rear roller portions of said reel-type mowers.

14. The method of mowing grass of claim 13 adjusting to ground contours at least in part by pivoting said reel-type mowers relative to one another.

15. The method of mowing grass of claim 13 wherein said moving step includes a step of providing electric power to an electric motor; and
said steering step includes a step adjusting a division of torque between at least two propulsion wheels.
